(19) United States
(12) Patent Application Publication
(10) Pub. No.: US 2024/0236853 A1
(43) Pub. Date: Jul. 11, 2024

(54) BLUETOOTH LOW ENERGY MESH NETWORK SYSTEM AND NETWORK CONTROL METHOD

(71) Applicant: REALTECK SEMICONDUCTOR CORPORATION, HSINCHU (TW)

(72) Inventors: HUAN SUN, Suzhou (CN); Xiao-Dan Xu, Suzhou (CN); Si-Yuan Wang, Suzhou (CN)

(21) Appl. No.: 18/401,748

(22) Filed: Jan. 2, 2024

(30) Foreign Application Priority Data
Jan. 5, 2023 (CN) 202310012987.8

(51) Int. Cl. H04W 52/02

(52) U.S. Cl. CPC H04W 52/0229; H04W 52/0235

(57) ABSTRACT

A Bluetooth low energy mesh network system includes a transmission controller circuit and a host controller circuit. The transmission controller circuit is configured to determine whether an advertising packet comprises a message associated with a Bluetooth low energy mesh network. The host controller circuit is configured to be woke up from a sleep mode in response to a report from the transmission controller circuit when the transmission controller circuit determines that the advertising packet comprises the message, in order to transmit the message to an application layer.

### BACKGROUND OF THE INVENTION

### 1. Field of the Invention

The present disclosure relates to a Bluetooth low energy network system, especially to a Bluetooth low energy network system that filter packet(s) to save the power consumption and a network control method thereof.

### 2. Description of Related Art

With the development of technology, more and more home appliances are equipped with intelligent control functions to provide users with remote control. In the existing approaches, Bluetooth low energy mesh networks are often set in the application environment to facilitate individual nodes (e.g., the aforementioned home appliances) to communicate with each other or receive message(s) from the user. In the existing approaches, controllers related to the Bluetooth low energy protocol in these nodes need to be in an active (or enable) state for a long time to check whether the received packet is a message from the user for subsequent processing. As a result, the overall power consumption will increase.

### SUMMARY OF THE INVENTION

In some aspects, an object of the present disclosure is to, but not limited to, provide a Bluetooth low energy network system that filter packet(s) to save the power consumption and a network control method thereof, in order to make an improvement to the prior art.

In some aspects, a Bluetooth low energy mesh network system includes a transmission controller circuit and a host controller circuit. The transmission controller circuit is configured to determine whether an advertising packet comprises a message associated with a Bluetooth low energy mesh network. The host controller circuit is configured to be woke up from a sleep mode in response to a report from the transmission controller circuit when the transmission controller circuit determines that the advertising packet comprises the message, in order to transmit the message to an application layer.

In some aspects, a network control method includes the following operations: determining, by a transmission controller circuit, an advertising packet comprises a message associated with a Bluetooth low power mesh network; and waking up a host controller circuit that operates in a sleep mode when the adverting packet is determined to comprise the message, in order to transmit the message to an application layer by the host controller circuit.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a Bluetooth low energy mesh network system according to some embodiments of the present disclosure.

FIG. 2 illustrates a flowchart of operations performed by the transmission controller circuit and the host controller circuit in FIG. 1 according to some embodiments of the present disclosure.

FIG. 3 illustrates a flowchart of operations performed by the transmission controller circuit and the host controller circuit in FIG. 1 according to some embodiments of the present disclosure.

FIG. 4 illustrates a flowchart of a network control method according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

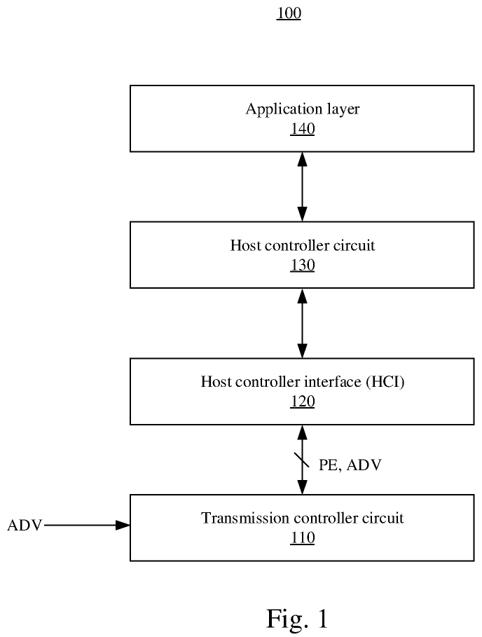

FIG. 1 illustrates a schematic diagram of a Bluetooth low energy (BLE) mesh network system 100 according to some embodiments of the present disclosure. The BLE mesh network system 100 includes a transmission controller circuit 110, a host controller interface (HCI) 120, a host controller circuit 130, and an application layer 140.

In some embodiments, each of the transmission controller circuit 110 and the host controller circuit 130 may be implemented with a microcontroller circuit. The transmission controller circuit 110 mainly handles data transmission, and the host controller circuit 130 mainly manages data processing and communicates with the application layer 140. For example, the transmission controller circuit 110 may transmit or receive radio frequency signals (e.g., receiving an advertising packet ADV) and parse the advertising packet ADV to determine whether to report (e.g., transmit) the advertising packet ADV to the host controller circuit 130 via the HCI 120. The transmission controller circuit 110 and the host controller circuit 130 communicate with each other through the HCI 120. For example, the transmission controller circuit 110 may send an event packet PE and data (e.g., the advertising packet ADV or the advertising packet ADV after being initial parsed) to the host controller circuit 130 via the HCI 120, thereby waking up the host controller circuit 130. The host controller circuit 130 may issue commands or data to the transmission controller circuit 110 through the HCI 120 to perform data transmission. In some embodiments, the HCI 120 may support various transmission protocols which includes, but not limited to, UART, USB, SPI, RS232, or the like.

According to BLE specification(s), the host controller circuit 130 may operate with a mesh stack (not shown) and a generic access profile (not shown). The mesh stack includes various services under BLE specifications, including, for example, bearer layers, network layers, transport layers, model layers, etc., which may manage communication between various devices and offer different services. The application layer 140, which is operated by a processor in the system (not shown), includes numerous software, which may be employed to implement practical applications within the mesh network, such as playing music, controlling smart home devices, or the like.

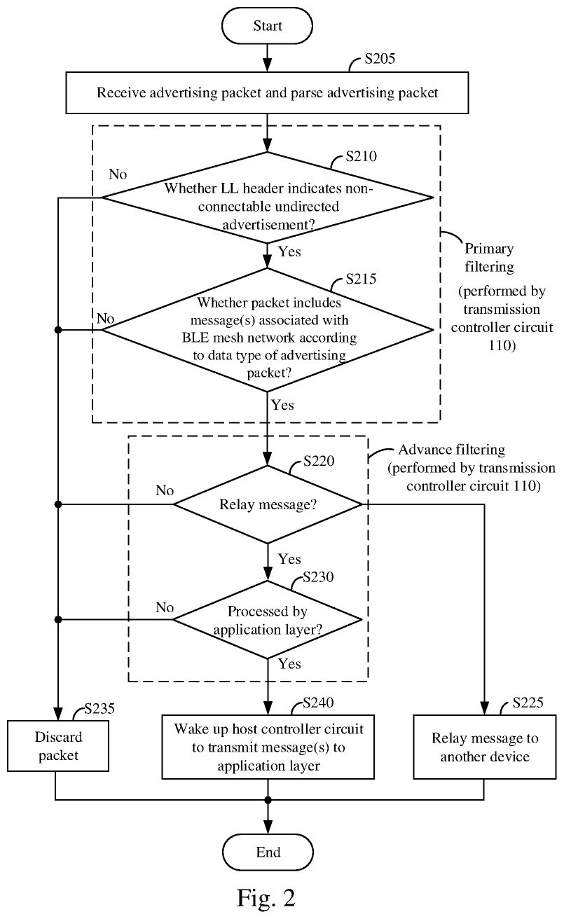

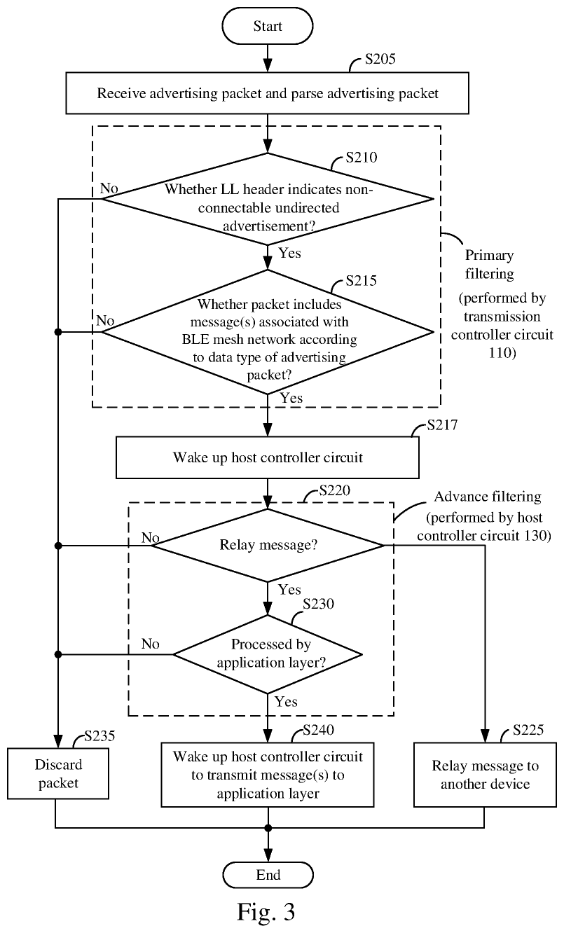

In some embodiments, the transmission controller circuit 110 may perform a primary filtering (and/or an advanced filtering) on the advertising packet ADV to exclude a packet that does not carry BLE mesh network message(s). If the transmission controller circuit 110 determines that the advertising packet ADV includes message(s) associated with the BLE mesh network, the transmission controller circuit 110 may further determine whether to transmit the event packet PE and the advertising packet to the host controller circuit 130, thereby waking up the host controller circuit 130 that operates in a sleep mode. In this way, the host controller circuit 130 may report the message to the application layer 140. Alternatively, if the transmission controller circuit 110 determines that the advertising packet ADV excludes message(s) associated with the BLE mesh network, the transmission controller circuit 110 may discard that packet. As a result, the host controller circuit 130 may continue operating in the sleep mode. In other words, for most operational durations, the host controller circuit 130 may operate in the sleep mode to save overall power consumption. Detailed descriptions regarding herein will be given with reference to FIGS. 2 and 3. In some embodiments, the aforementioned sleep mode broadly refers to an operational mode with a lower power consumption, such as a power-saving mode or a standby mode.

In some related approaches, the transmission controller circuit is configured to report the received advertising packet to the host controller circuit, and the host controller circuit may parse the advertising packet and determine whether the advertising packet includes the BLE mesh network messages and proceed with subsequent processing. In the aforesaid approaches, both of the transmission controller circuit and the host controller circuit need to consistently operate in an active state to parse the received advertising packet. As previously mentioned, in some embodiments of the present disclosure, the host controller circuit 130 may operate in the sleep mode for the most operational durations. Accordingly, compared with the aforementioned approaches, the BLE mesh network system 100 is able to have a lower power consumption.

FIG. 2 illustrates a flowchart of operations performed by the transmission controller circuit 110 and the host controller circuit 130 in FIG. 1 according to some embodiments of the present disclosure. In FIG. 2, operations S205, S210, S215, S220, S225, S230, and S235 are performed by the transmission controller circuit 110, and operation S240 is performed by the host controller circuit 130.

In operation S205, the advertising packet is received and parsed. For example, the transmission controller circuit 110 may receive the advertising packet ADV from other nodes and parse the advertising packet ADV. According to BLE specification(s), the advertising packet ADV has a multilayered structure. The transmission controller circuit 110 may unpack the advertising packet ADV to obtain data fields included in the advertising packet ADV.

In operation S210, whether a link layer (LL) header in the advertising packet indicates a non-connectable undirected advertisement is determined. If the link layer header indicates the non-connectable undirected advertisement, operation S215 is performed. Alternatively, if the link layer header does not indicate the non-connectable undirected advertisement, operation S235 is performed. For example, after unpacking the advertising packet ADV, the transmission controller circuit 110 may obtain the LL packet header from the advertising packet ADV and determine whether a protocol data unit (PDU) type in the LL packet header is ADV_NONCONN_IND. If the PDU type is ADV_NONCONN_IND, it means that the link layer header indicates a non-connectable undirected advertisement (as per BLE specification). In other words, the advertising packet ADV is a non-connectable undirected advertising packet. Under this condition, there is a probability that the advertising packet ADV includes message(s) associated with the BLE mesh network, and thus the transmission controller circuit 110 may perform operation S215 to proceed to parse the advertising packet ADV.

In operation S215, whether the advertising packet includes message(s) associated with the BLE mesh network is determined according to the data type of the advertising data in the advertising packet. If the advertising packet includes such message, operation S220 is performed. Alternatively, if the advertising packet does not include such message, operation S235 is performed.

For example, after unpacking the advertising packet ADV, the transmission controller circuit 110 may further obtain the data type field in the advertising data of the advertising packet ADV and determine if the data type indicates mesh network data or a mesh network beacon. According to the BLE specification, if the data type field is 0x2A, it indicates mesh network data. Similarly, if the data type field is 0x2B, it indicates a mesh network beacon. If the data type indicates mesh network data or beacon, there is a higher probability that the advertising packet ADV may include message associated with the BLE mesh network. Under this condition, the transmission controller circuit 110 may perform operation S220 to determine whether to wake up the host controller circuit 130.

In operation S220, whether to relay the message to another device is determined. If the message is to be relayed to another device, operation S225 is performed. If the message is not to be relayed to another device, operation S235 is performed. In operation S225, the message is relayed to the other device.

For example, after unpacking the advertising packet ADV, the transmission controller circuit 110 may determine, based on a relay message in the advertising packet ADV, whether to relay the message associated with the BLE mesh network to another device. If the message is to be relayed to another device, the transmission controller circuit 110 may directly relay the message to the other device without waking up the host controller circuit 130.

In operation S230, whether the message is to be processed by the application layer is determined. If the message is determined to be processed by the application layer, operation S240 is performed. Alternatively, if the message is determined to be not processed by the application layer, operation S235 is performed. In operation S240, the host controller circuit is woke up to transmit the message to the application layer. In operation S235, the advertising packet is discarded.

For example, after unpacking the advertising packet ADV, the transmission controller circuit 110 may determine, based on data in the advertising packet ADV, whether the data requires specific software for special processing or handling (e.g., encryption or decryption). If the data requires specific software for subsequent processing, the transmission controller circuit 110 may report to the host controller circuit 130 through the HCI 120, in order to wake up the host controller circuit 130 from the sleep mode. As a result, the host controller circuit 130 may transmit the message in the advertising packet ADV to the application layer 140 for further processing. Alternatively, if information in the advertising packet ADV does not meet the conditions set in operations S210, S215, or S230, the transmission controller circuit 110 may determine that the advertising packet ADV excludes message(s) associated with mesh network and may discard the advertising packet ADV.

In the aforementioned operations, operations S210 and S215 are considered as the primary filtering on the advertising packet ADV, and operations S220 and S230 are considered as the advanced filtering on the advertising packet ADV. With the primary filtering, advertising packets frequently emitted by BLE peripheral devices may be excluded. With the advanced filtering, messages that only need to be relayed or unknown redundant messages (or perceived as network attacks) may be excluded. As a result, the types of packets that need to be processed by the host controller circuit 130 may be significantly reduced, such that the host controller circuit 130 is able to operate in the sleep mode in most situations, in order to reduce overall power consumption.

For example, in a BLE mesh network, there is a node which may be a smart light fixture. For this node, the only mesh network message needs to be processed by the application layer 140 is on/off light command(s) from user(s). However, the node may frequently receive other communication messages from other nodes or advertising packet(s) from BLE peripheral devices for most operational durations. With the aforementioned primary filtering and advanced filtering, it is able to wake up the transmission controller circuit 110 only when receiving the on/off light command(s) from user(s). As a result, the overall power consumption of the smart light fixture can be reduced.

FIG. 3 illustrates a flowchart of operations performed by the transmission controller circuit 110 and the host controller circuit 130 in FIG. 1 according to some embodiments of the present disclosure. As previously mentioned, in FIG. 2, operations corresponding to the primary and advanced filtering are performed by the transmission controller circuit 110. Different from FIG. 2, in FIG. 3, operations corresponding to advanced filtering (which may include, for example, operations S220, S230, and operation S225 that is performed in response to operation S220) are performed by the host controller circuit 130. In other words, if the transmission controller Circuit 110 determines that the advertising packet ADV includes message(s) associated with a BLE mesh network in operation S215, the transmission controller circuit 110 may perform operation S217 to wake up the host controller circuit 130 that operates in sleep mode. As a result, the host controller circuit 130 may perform operations S220, S225, S230, and S240. Due to the majority of operations being analogous to those in FIG. 2, repetitious descriptions are not further given herein.

Operations in FIGS. 2-3 can be understood with reference to descriptions of above embodiments, and thus repetitious descriptions are not further given herein. The above description of multiple operations includes exemplary operations, but the operations are not necessarily performed in the order described above. Operations of in FIGS. 2-3 may be added, replaced, changed order, and/or eliminated, or the operations in FIGS. 2-3 may be performed simultaneously or partially simultaneously as appropriate, in accordance with the spirit and scope of various embodiments of the present disclosure. For example, operations S220 and S230 may be performed simultaneously.

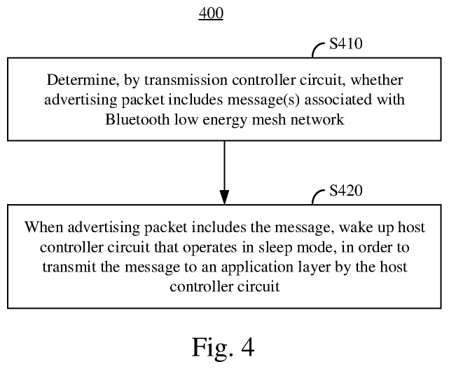

FIG. 4 illustrates a flowchart of a network control method 400 according to some embodiments of the present disclosure. In operation S410, whether an advertising packet include message(s) associated with a Bluetooth Low Energy mesh network is determined by a transmission controller circuit. In operation S420, when the advertising packet includes the message, a host controller circuit that operates in a sleep mode is woke up, in order to transmit the message to an application layer by the host controller circuit.

The above operations of the network control method 400 can be understood with reference to above embodiments, and thus the repetitious descriptions are not further given. The above description of the network control method 400 includes exemplary operations, but the operations of the network control method 400 are not necessarily performed in the order described above. Operations of the network control method 400 may be added, replaced, changed order, and/or eliminated, or the operations of the network control method 400 may be performed simultaneously or partially simultaneously as appropriate, in accordance with the spirit and scope of various embodiments of the present disclosure.

As described above, the BLE mesh network system and the network control method provided in some embodiments of the present disclosure may filter the advertising packet with a controller circuit responsible for data transmission. As a result, for majority of operational duration, a host controller circuit for data processing is able to operate in the sleep mode to save overall power consumption.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A Bluetooth low energy mesh network system, comprising:
a transmission controller circuit configured to determine whether an advertising packet comprises a message associated with a Bluetooth low energy mesh network; and
a host controller circuit configured to be woke up from a sleep mode in response to a report from the transmission controller circuit when the transmission controller circuit determines that the advertising packet comprises the message, in order to transmit the message to an application layer.

2. The Bluetooth low energy mesh network system of claim 1, wherein the transmission controller circuit is configured to determine whether a link layer packet header of the advertising packet indicates a non-connectable undirected advertisement, and if the link layer packet header indicates the non-connectable undirected advertisement, the transmission controller circuit is further configured to determine whether the advertising packet comprises the message according to a data type of an advertising data in the advertising packet.

3. The Bluetooth low energy mesh network system of claim 2, wherein if the data type indicates a mesh network data or a mesh network beacon, the transmission controller circuit determines that the advertising packet comprises the message.

4. The Bluetooth low energy mesh network system of claim 1, wherein if the transmission controller circuit determines that the advertising packet comprises the message, the transmission controller circuit is further configured to wake up the host controller circuit through a host controller interface, such that the host controller circuit transmits the message to the application layer.

5. The Bluetooth low energy mesh network system of claim 1, wherein if the transmission controller circuit determines that the advertising packet comprises the message, the transmission controller circuit is further configured to determine whether to relay the message to another device.

6. The Bluetooth low energy mesh network system of claim 5, wherein if the transmission controller circuit determines to relay the message to the another device, the transmission controller circuit is configured to relay the message to the another device without waking up the host controller circuit.

7. The Bluetooth low energy mesh network system of claim 1, wherein if the transmission controller circuit determines that the advertising packet comprises the message, the transmission controller circuit is further configured to wake up the host controller circuit through a host controller interface, and the host controller circuit is further configured to determine whether the message is to be processed by the application layer, in order to transmit the message to the application layer.

8. The Bluetooth low energy mesh network system of claim 1, wherein if the transmission controller circuit determines that the advertising packet comprises the message, the transmission controller circuit is further configured to wake up the host controller circuit through a host controller interface, and the host controller circuit is further configured to determine whether to relay the message to another device.

9. The Bluetooth low energy mesh network system of claim 1, wherein if the transmission controller circuit determines that the advertising packet excludes the message, the host controller circuit continues operating in the sleep mode.

10. The Bluetooth low energy mesh network system of claim 1, wherein if the transmission controller circuit determines that the advertising packet excludes the message, the transmission controller circuit is configured to discard the advertising packet.

11. A network control method, comprising:
determining, by a transmission controller circuit, an advertising packet comprises a message associated with a Bluetooth low power mesh network; and
waking up a host controller circuit that operates in a sleep mode when the adverting packet is determined to comprise the message, in order to transmit the message to an application layer by the host controller circuit.

12. The network control method of claim 11, wherein determining, by the transmission controller circuit, the advertising packet comprises the message comprises:
determining whether a link layer packet header of the advertising packet indicates a non-connectable undirected advertisement; and
if the link layer packet header indicates the non-connectable undirected advertisement, determining whether the advertising packet comprises the message according to a data type of an advertising data in the advertising packet.

13. The network control method of claim 12, wherein if the data type indicates a mesh network data or a mesh network beacon, the advertising packet is determined to comprise the message.

14. The network control method of claim 11, further comprising:
determining, by the transmission controller circuit, whether the message is to be processed by the application layer if the advertising packet is determined to comprise the message; and
waking up, by the transmission controller circuit, the host controller circuit through a host controller interface if the message is to be processed by the application layer, such that the host controller circuit transmits the message to the application layer.

15. The network control method of claim 11, further comprising:
determining, by the transmission controller circuit, whether to relay the message to another device if the advertising packet comprises the message.

16. The network control method of claim 15, further comprising:
relaying, by the transmission controller circuit, to the another device without waking up the host controller circuit if the transmission controller circuit determines to relay the message to the another device.

17. The network control method of claim 11, further comprising:
waking up, by the transmission controller circuit, the host controller circuit through a host controller interface if the advertising packet is determined to comprise the message;
determining, by the host controller circuit, whether the message is to be processed by the application layer; and
transmitting, by the host controller circuit, the message to the application layer if the message is to be processed by the application layer.

18. The network control method of claim 11, further comprising:
waking up, by the transmission controller circuit, the host controller circuit through a host controller interface if the advertising packet is determined to comprise the message; and
determining, by the host controller circuit, whether to relay the message to another device.

19. The network control method of claim 11, wherein if the advertising packet is determined to exclude the message, the host controller circuit is not woke up, such that the host controller circuit continues operating in the sleep mode.

20. The network control method of claim 11, further comprising:
discarding the advertising packet if the advertising packet is determined to exclude the message.
